(19) United States
(12) Patent Application Publication
(10) Pub. No.: US 2024/0321510 A1
(43) Pub. Date: Sep. 26, 2024

(54) SLIM MAGNETIC COUPLING DEVICE WITH STABLE WITHSTANDING VOLTAGE CHARACTERISTICS

(71) Applicant: LG INNOTEK CO., LTD., Seoul (KR)

(72) Inventors: Jung Eun LEE, Seoul (KR); Bi Yi KIM, Seoul (KR); Seok BAE, Seoul (KR)

(21) Appl. No.: 18/572,970

(22) PCT Filed: Jun. 29, 2022
(86) PCT No.: PCT/KR2022/009310

§ 371 Date: Dec. 21, 2023

(30) Foreign Application Priority Data
Jul. 1, 2021 (KR) 10-2021-0086204

(51) Int. Cl. H01F 27/32; H01F 27/26; H01F 27/29

(52) U.S. Cl. CPC H01F 27/325; H01F 27/266; H01F 27/29; H01F 27/323

(57) ABSTRACT

A magnetic coupling device according to an embodiment of the present invention includes a first bobbin including an upper surface, a lower surface, and an outer surface, a groove portion which is disposed on the inner side of the outer surface and is concave from the upper surface toward the lower surface, and a first terminal portion and a second terminal portion which are disposed on the outer surface and spaced apart from each other; a second bobbin disposed on the groove portion and accommodating a magnetic substance core; and a first coil and a second coil which are wound on the second bobbin and spaced apart from each other, wherein the first coil includes a first winding portion and a first extension portion, and the second coil includes a second winding portion, and a second extension portion.

### TECHNICAL FIELD

The present disclosure relates to a slim magnetic coupling device, particularly, a magnetic component such as, for example, an inductor or a transformer.

### BACKGROUND ART

As slimness of products, for example, TVs, accelerates, there is great demand for slim magnetic components. According to such demand, in order to reduce a mounting area and to secure price competitiveness, components have currently become miniaturized.

However, miniaturization of magnetic components causes a problem in which the withstand voltage characteristics thereof become unstable and heat is generated, so a countermeasure thereto is required.

Illustratively, FIG. 1 shows a conventional EMI filter, which includes a second bobbin 1a formed in a cylindrical donut shape and accommodating a core therein, first and second coils 2a and 2b wound on both sides of the second bobbin 1a with respect to the center portion of the second bobbin 1a, and a first bobbin 1b provided separately from the second bobbin 1a and including a recess formed in the center thereof to allow the first and second coils 2a and 2b to be received therein in a state of being wound on the second bobbin 1a and bobbin extension portions extending from two opposite points of the recess and having a plurality of terminals mounted thereto.

Such a conventional EMI filter has the following problems because the terminals are gathered on two opposite sides thereof.

1) Because a distance between each of pairs of terminals (3a and 3d) (3b and 3c), to which a corresponding pair of extension portions of the first and second coils is connected, is short, the withstand voltage characteristics become more unstable as the size of the component decreases.

2) It is difficult to secure a sufficient terminal area due to spatial limitations, and accordingly, when the size of the terminal increases, the overall size of the component increases, and the withstand voltage characteristics thereof are further deteriorated.

3) There is a limitation on miniaturization because the component inevitably has a relatively long length w1 in one direction.

### DISCLOSURE

### Technical Problem

An object of the present disclosure is to solve at least one of the above problems with the related art.

That is, the present disclosure provides a magnetic coupling device or a magnetic component that is suitable for a miniaturized structure and has stable and improved withstand voltage characteristics by securing a sufficient distance between terminals.

### Technical Solution

A magnetic coupling device according to an embodiment of the present disclosure includes a first bobbin, which includes an upper surface, a lower surface formed opposite the upper surface, an outer side surface formed between the upper surface and the lower surface, a recessed portion disposed inside the outer side surface and depressed in the upper surface toward the lower surface, and first and second terminal parts disposed on the outer side surface so as to be spaced apart from each other in a first direction, a second bobbin, which is disposed in the recessed portion and accommodates a magnetic core therein, and first and second coils, which are wound on the second bobbin and are spaced apart from each other in the first direction, wherein the first coil includes a first wound portion wound on the second bobbin and a first extension portion extending from the first wound portion to a region on the outer side surface of the first bobbin to be coupled to the first terminal part, and the second coil includes a second wound portion wound on the second bobbin and a second extension portion extending from the second wound portion to a region on the outer side surface of the first bobbin to be coupled to the second terminal part.

In at least one embodiment of the present disclosure, the second bobbin includes a pair of isolation protrusions, and the first wound portion and the second wound portion are isolated from each other by the pair of isolation protrusions.

In at least one embodiment of the present disclosure, a start angle at which the first extension portion and the second extension portion escape from the recessed portion is 250 or more with respect to a virtual straight line connecting the pair of isolation protrusions.

In addition, the start angle may be 50° or less.

In at least one embodiment of the present disclosure, the terminal part is spaced apart from the isolation protrusion by 5 mm or more.

In addition, the terminal part may be disposed in alignment with a virtual parallel line passing through a portion of the first coil or the second coil located farthest from each of the isolation protrusions and extending parallel to the virtual straight line connecting the pair of isolation protrusions.

In at least one embodiment of the present disclosure, the first bobbin includes a pair of bobbin extension portions extending from two opposite sides of the recessed portion, and a central portion of each of the bobbin extension portions is formed such that a distance from the recessed portion to an outermost portion of each of the bobbin extension portions in a given direction is shorter than a length of the first terminal part or the second terminal part in the given direction.

Here, the central portion of each of the bobbin extension portions may include a second isolation protrusion.

In addition, in at least one embodiment of the present disclosure, the first bobbin is formed to be at least partially convex in an outward direction along the shape of the recessed portion.

In at least one embodiment of the present disclosure, the terminal part is mounted on the first bobbin so as to cover the upper surface, the lower surface, and the outer side surface of the first bobbin.

Here, the extension portion may be inserted into a region between the outer side surface and the terminal part.

In at least one embodiment of the present disclosure, an angle θ1 between the last turn of the first coil and the last turn of the second coil corresponding thereto is 200 to 100°.

In addition, in at least one embodiment of the present disclosure, an angle θ2 formed by the first terminal part and the second terminal part with respect to the center of the second bobbin is 20° to 100°.

In addition, an angle ratio θ2/θ1 may be 0.2 to 5.

In at least one embodiment of the present disclosure, the first bobbin further includes a third terminal part and a fourth terminal part, and the first to fourth terminal parts are mounted outside the recessed portion so as to be disposed in regions corresponding to four quadrants of the recessed portion.

In at least one embodiment of the present disclosure, the first extension portion and the second extension portion escape from the recessed portion and diverge from each other at an increasing angle to be connected to the first terminal part and the second terminal part, respectively.

In at least one embodiment of the present disclosure, the first bobbin further includes a guide groove portion formed in an outer surface thereof.

Here, the guide groove portion may further include a first guide groove portion and a second guide groove portion, and the first extension portion and the second extension portion may be disposed in the first guide portion and the second guide portion, respectively.

In addition, the guide groove portion may be connected to the recessed portion in which the second bobbin is disposed.

In at least one embodiment of the present disclosure, the first bobbin includes radial extension portions extending from the recessed portion in a radial direction, and the terminal part is mounted on each of the radial extension portions.

### Advantageous Effects

According to the present disclosure, a magnetic component suitable for a miniaturized structure may be obtained.

In addition, a magnetic coupling device or a magnetic component according to the present disclosure exhibits stable withstand voltage characteristics in spite of reduction in the size thereof.

Additional effects of the present disclosure will be apparently understood by those skilled in the art from the following description of embodiments of the present disclosure.

### DESCRIPTION OF DRAWINGS

FIG. 1 illustrates an EMI filter as a conventional magnetic component.

FIG. 2 illustrates an EMI filter as an embodiment of the present disclosure.

FIG. 3 illustrates a cross-section taken along line A-A in FIG. 2.

FIG. 4 illustrates a part of an EMI filter as a second embodiment of the present disclosure.

FIG. 5 illustrates a part of an EMI filter as a third embodiment of the present disclosure.

FIG. 6 illustrates a part of an EMI filter as a fourth embodiment of the present disclosure.

### BEST MODE

The present disclosure may make various changes and have various embodiments, and specific embodiments are illustrated and described in the drawings. However, this is not intended to limit the present disclosure to a specific embodiment, and should be understood to include all changes, equivalents, or substitutes included in the spirit and technical scope of the present disclosure.

The suffixes “module” and “unit” used in this specification are only used for denominative distinction between elements, and should not be construed as presuming that the terms are physically and chemically distinguished or separated or may be distinguished or separated in that way.

Although terms including ordinal numbers, such as “first”, “second”, etc., may be used herein to describe various elements, the elements are not limited by these terms. These terms are only used to distinguish one element from another.

The term “and/or” is used to include any combination of a plurality of items that are the subject matter. For example, “A and/or B” inclusively means all three cases such as “A”, “B”, and “A and B”.

It will be understood that when a component is referred to as being “connected to” or “coupled to” another component, it may be directly connected to or coupled to another component, or intervening components may be present.

In the description of the embodiments, it will be understood that when an element, such as a layer (film), a region, a pattern or a structure, is referred to as being “on” or “under” another element, such as a substrate, a layer (film), a region, a pad or a pattern, the term “on” or “under” means that the element is directly on or under another element or is formed such that an intervening element may also be present. In addition, it will also be understood that criteria of “on” or “under” is on the basis of the drawing for convenience unless otherwise defined due to the characteristics of each of components or the relationship therebetween. The term “on” or “under” is used only to indicate the relative positional relationship between components and should not be construed as limiting the actual positions of the components. For example, the phrase “B on A” merely indicates that B is illustrated in the drawing as being located on A, unless otherwise defined or unless A must be located on B due to the characteristics of A or B. In an actual product, B may be located under A, or B and A may be disposed in a leftward-rightward direction.

In addition, the thickness or size of a layer (film), a region, a pattern, or a structure shown in the drawings may be exaggerated, omitted, or schematically drawn for the clarity and convenience of explanation, and may not accurately reflect the actual size.

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the terms “include” or “have”, when used herein, specify the presence of stated features, integers, steps, operations, elements, components, or combinations thereof, but do not preclude the presence or addition of one or more other features, integers, steps, operations, elements, components, or combinations thereof.

Unless defined otherwise, all terms used herein, including technical or scientific terms, have the same meanings as commonly understood by one of ordinary skill in the art to which the present disclosure belongs. Terms such as those defined in commonly used dictionaries should be interpreted as having meanings consistent with the meanings in the context of the related art, and unless explicitly defined in this application, the terms should not be interpreted as having ideal or excessively formal meanings.

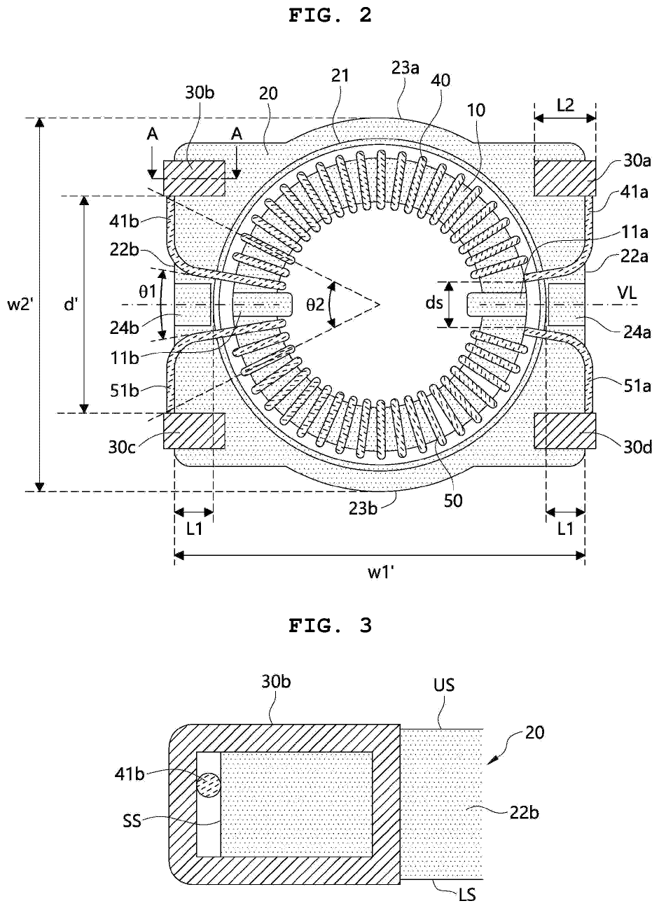

FIG. 2 illustrates an EMI filter as an embodiment of the present disclosure, and FIG. 3 illustrates a cross-section taken along line A-A in FIG. 2.

The EMI filter of this embodiment includes a second bobbin 10, a first bobbin 20, a first coil 40, and a second coil 50.

The second bobbin 10 is provided separately from the first bobbin 20, and a magnetic core (not shown) is accommodated therein. For example, the magnetic core may be structured such that an amorphous ribbon is wound like a scroll.

The second bobbin 10 has a substantially circular donut shape, and is provided in the substantially middle thereof with a pair of isolation protrusions 11a and 11b.

The second bobbin 10 is divided into a first section (an upper section in the drawings) and a second section (a lower section in the drawings) by the pair of isolation protrusions 11a and 11b, and the two sections are isolated from each other by the isolation protrusions 11a and 11b from a viewpoint of winding of the first coil 40 and the second coil 50.

The second bobbin 10 may include a lower part having a U-shaped cross-section and an upper part having an inverted U-shaped cross-section, and may have a structure in which the upper part and the lower part overlap each other to be coupled to each other in a state of accommodating magnetic cores therein.

The first coil 40 is wound on the first section, which is one section of the second bobbin 10, and the second coil 50 is wound on the second section of the second bobbin 10.

The first bobbin 20 includes a recessed portion 21 formed in the center thereof, and the first coil 40 and the second coil 50 are seated in the recessed portion 21 in a state of being wound on the second bobbin 10.

The recessed portion 21 has a structure in which a through-hole is formed in the center thereof, a seating portion extends from the circumferential edge of the through-hole in a radially outward direction, and a peripheral wall is formed to a predetermined height from the outer circumference of the seating portion.

In addition, the first bobbin 20 includes a first bobbin extension portion 22a and a second bobbin extension portion 22b, which extend from two opposite sides of the recessed portion 21 in a direction of a virtual straight line VL connecting the pair of isolation protrusions 11a and 11b of the second bobbin 10.

Terminal parts (or terminals) 30a, 30b, 30c, and 30d are mounted at four points on the two bobbin extension portions 22a and 22b. As shown in FIG. 2, the terminal parts 30a, 30b, 30c, and 30d are mounted outside the recessed portion 21 so as to be disposed in regions corresponding to four quadrants of the recessed portion 21. That is, a first terminal part 30a is mounted in a region corresponding to a first quadrant, a third terminal part 30b is mounted in a region corresponding to a second quadrant, a fourth terminal part 30c is mounted in a region corresponding to a third quadrant, and a second terminal part 30d is mounted in a region corresponding to a fourth quadrant.

The first terminal part 30a and the third terminal part 30b are disposed so as to be spaced apart from the second terminal part 30d and the fourth terminal part 30c in a first direction (a vertical direction in FIG. 2), respectively.

The central portions of the bobbin extension portions 22a and 22b corresponding to the isolation protrusions 11a and 11b may be formed such that a distance L1 from the recessed portion 21 to the outermost portion of each of the bobbin extension portions 22a and 22b is short, and the terminal parts 30a, 30b, 30c, and 30d may be disposed sufficiently far from the central portions of the bobbin extension portions 22a and 22b, whereby there are no spatial limitations on mounting of the terminal parts 30a, 30b, 30c, and 30d, and the upper surfaces or lower surfaces (mounted surfaces) of the terminal parts 30a, 30b, 30c, and 30d may be increased in area.

That is, the distance L1 may be shorter than a length L2 of the terminal part in the direction of the virtual straight line VL, and the terminal parts 30a, 30b, 30c, and 30d may be mounted on regions of the bobbin extension portions 22a and 22b that have a sufficient length in the direction of the virtual straight line VL. Accordingly, the overall length w1′ of the EMI filter in the direction of the virtual straight line VL may be reduced.

In addition, the bobbin extension portions 22a and 22b include second isolation protrusions 24a and 24b formed on the central portions thereof, whereby extension portions 41a and 41b of the first coil 40 and extension portions 51a and 51b of the second coil 50 may be more reliably isolated from each other.

In addition, among the extension portions 41a and 41b of the first coil 40 and the extension portions 51a and 51b of the second coil 50, a pair of extension portions 41a and 51a disposed opposite each other with respect to the virtual straight line VL escapes from the recessed portion 21 and diverges from each other at an increasing angle to be connected to the terminal parts 30a and 30d, and a pair of extension portions 41b and 51b disposed opposite each other with respect to the virtual straight line VL escapes from the recessed portion 21 and diverges from each other at an increasing angle to be connected to the terminal parts 30b and 30c.

In this embodiment, the minimum distance ds between the pair of extension portions 41a and 51a and the minimum distance ds between the pair of extension portions 41b and 51b may be determined by the positions of the last turns of the coils on the second bobbin 10 (the last turns of the coils are portions directly connected to the extension portions extending to the terminals), and the distance between each pair of portions extending from the last turns of the coils to the outside of the recessed portion 21 so as to be connected to the terminal parts 30a, 30b, 30c, and 30d is gradually increased. Due to this structure, the EMI filter of this embodiment may exhibit stable withstand voltage characteristics.

Referring to FIG. 2, as a representative example, an angle θ1 between the last left turn of the first coil 40 and the last left turn of the second coil 50 is 20° to 100°. If the angle θ1 is less than 20°, the distance between the wires of the coils greatly decreases, which may lead to withstand voltage defects, and if the angle θ1 is greater than 100°, the space for winding is structurally reduced, which may lead to overlap between the wires during winding and resultant increase in the overall height of the component.

In addition, referring to FIG. 2, the terminal 30b for the first coil 40 and the terminal 30c for the second coil 50 corresponding thereto form an angle θ2 of 20° to 100° therebetween with respect to the center of the second bobbin 10 or the center formed by the first and second coils 40 and 50.

If the angle θ2 is less than 20°, the distance between the wires decreases when the coil extension portions are connected to the terminals, which leads to withstand voltage defects, and if the angle θ2 is greater than 100°, the distance between the terminals increases, and thus the lengths of the wires for connection to the terminals increase, which leads to increase in resistance.

Meanwhile, a ratio (θ2/θ1) between the angles θ1 and θ2 is preferably 0.2 to 5. If the angle ratio is less than 0.2, the overall height of the component may increase due to a lack of space for winding of the wires, and if the angle ratio is greater than 5, the distance between the terminals increases, and thus the lengths of the wires for connection to the terminals increase, which may lead to increase in resistance and resultant heat generation.

FIG. 3 illustrates a configuration in which the terminal parts 30a, 30b, 30c, and 30d are mounted on the first bobbin 20 and the extension portions 41a, 41b, 51a, and 51b are connected to the terminal parts 30a, 30b, 30c, and 30d. As a representative example, only the third terminal part 30b is shown.

As shown in FIG. 3, the third terminal part 30b is mounted so as to cover an upper surface US, a lower surface LS, and an outer side surface SS of the first bobbin 20 while penetrating the first bobbin 20. In addition, the extension portion 41b of the first coil 40 is connected to the third terminal part 30b on the outer side surface SS. That is, the extension portion 41b extends from the last turn of the first coil 40 to the outside of the recessed portion 21, extends upward over the upper surface of the bobbin extension portion 22b of the first bobbin 20 while being curved at an increasing angle, extends downward to the outer side surface SS of the bobbin extension portion 22b, and then is inserted into a region between the outer side surface SS and the third terminal part 30b to be connected to the third terminal part 30b.

Due to this connection structure of the extension portions 41a, 41b, 51a, and 51b to the terminal parts 30a, 30b, 30c, and 30d, the overall thickness of the EMI filter may be further reduced.

In addition, the first bobbin 20 includes convex portions 23a and 23b formed convexly in an outward direction along the shape of the recessed portion 21 on at least portions of the outer side surfaces thereof that are formed opposite each other with respect to the virtual straight line VL.

The EMI filter of this embodiment may be miniaturized such that the overall length w2′ thereof in a direction perpendicular to the virtual straight line VL is not longer than that in the conventional structure and the overall length w1′ thereof in the direction of the virtual straight line VL is shorter than that in the conventional structure.

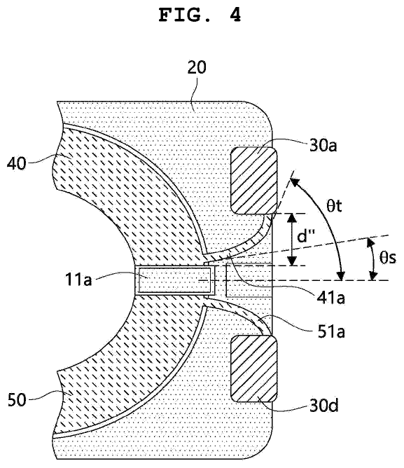

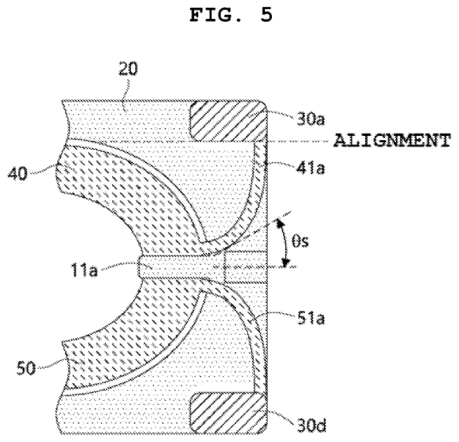

FIGS. 4 and 5 illustrate embodiments different from the above-described embodiment. Hereinafter, the same reference numerals will be used to explain the same components.

First, in the embodiment shown in FIG. 4, a representative value of a distance d″ by which the first terminal part 30a is spaced apart from the isolation protrusion 11a of the second bobbin 10 is 5 mm. That is, it is preferable for the spacing distance d″ between the first terminal part 30a and the isolation protrusion 11a to be 5 mm or more. If the spacing distance d″ is shorter than 5 mm, there arises a problem that the withstand voltage characteristics are not satisfied when 2.2 kV is applied.

In addition, it is preferable for a start angle θs at which the extension portions 41a and 51a escape from the recessed portion 21 to be 25°, and it is preferable for an end angle θt at which the extension portions 41a and 51a are connected to the terminal parts 30a and 30d to be 70° or more.

In the embodiment shown in FIG. 5, the terminal parts 30a and 30d are further spaced apart from the isolation protrusion 11a. Preferably, as illustrated, the edge of each of the terminal parts 30a and 30b that faces the virtual straight line VL is aligned with the outermost portion of the first coil 40. In addition, in the embodiment shown in FIG. 5, the start angle θs of each of the extension portions 41a and 51a is 50°.

The embodiments shown in FIGS. 4 and 5 may be combined. In this case, the spacing distance between each of the first and second terminal parts 30a and 30d and the isolation protrusion 11a may be 5 mm or more, the start angle θs of each of the extension portions 41a and 51a may be 25° to 50°, and the end angle θt of each of the extension portions 41a and 51a may be 70° or more.

The conventional EMI filter, in which the spacing distance between the terminal parts 30a and 30d and the spacing distance between the terminal parts 30b and 30c, which are disposed opposite each other with respect to the virtual straight line VL, are short and the extension portions 41a, 41b, 51a, and 51b are formed to be curved, may have a problem in that the required withstand voltage characteristics are not satisfied. In contrast, the EMI filter of the present disclosure secures sufficient spacing distances between the terminal parts 30a and 30d and between the terminal parts 30b and 30c, thereby exhibiting stable and satisfactory withstand voltage characteristics compared to the conventional EMI filter.

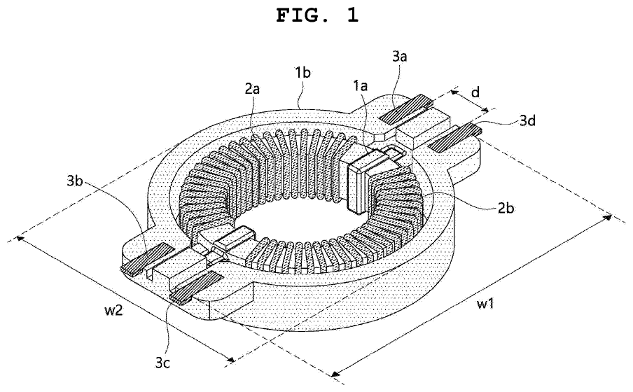

The table below is a table showing comparison between the withstand voltage characteristics of the conventional EMI filter shown in FIG. 1 and the withstand voltage characteristics of the EMI filter according to the embodiment of the present disclosure shown in FIG. 2.

TABLE 1

| | Conventional EMI Filter | Embodiment |
|---|---|---|
| | (Structure | (Structure |
| Classification | Shown in FIG. 1) | Shown in FIG. 2) |
| Component Size | 75 × 45 | 62 × 51 |
| (w1 × w2) | | |
| (w1′ × w2′) [mm] | | |
| Distance between | 11 | 32 |
| Terminals (d) (d′) [mm] | | |
| Terminal Area [mm²] | 12 | 25 |
| Withstand Voltage [kV] | ≤1.5 | 2.2 |

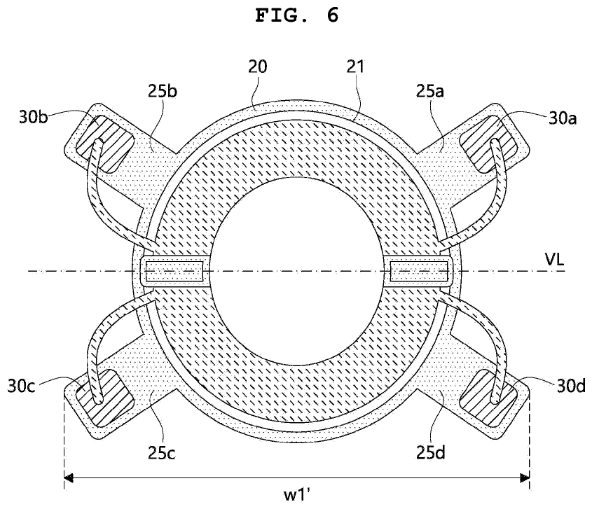

As shown in the table above, in the EMI filter according to the embodiment, the distance between the terminals and the area of the terminal greatly increase. In addition, while the conventional EMI filter has a withstand voltage of 1.5 kV or lower and thus does not satisfy required withstand voltage characteristics, the embodiment exhibits satisfactory withstand voltage characteristics for 2.2 kV. Meanwhile, FIG. 6 illustrates still another embodiment of the present disclosure.

The embodiment shown in FIG. 6 is different from the above-described embodiments only in the shape of the first bobbin 20.

The first bobbin 20 of this embodiment includes radial extension portions 25a, 25b, 25c, and 25d, which extend from four points around the recessed portion 21 in a radial direction and on which the terminal parts 30a, 30b, 30c, and 30d are respectively mounted. The terminal parts 30a, 30b, 30c, and 30d are mounted on the radial extension portions 25a, 25b, 25c, and 25d so as to be aligned in the radial direction.

In this embodiment, since the terminal parts 30a, 30b, 30c, and 30d are aligned in the radial direction, the overall length of the component in the direction of the virtual straight line VL may be further reduced while the areas or lengths of the terminals are maintained as they are, and accordingly, the component may be further miniaturized compared to the other embodiments.

Meanwhile, the technical contents of the above-described embodiments may be applied interchangeably between the embodiments unless they are contradictory and incompatible.

### MODE FOR INVENTION

Various embodiments have been described in the best mode for carrying out the disclosure.

### INDUSTRIAL APPLICABILITY

A magnetic coupling device according to embodiments may be used for TVs and the like.

1. A magnetic coupling device, comprising:
a first bobbin including an upper surface, a lower surface formed opposite the upper surface, an outer side surface formed between the upper surface and the lower surface, a recessed portion disposed inside the outer side surface and depressed in the upper surface toward the lower surface, and first and second terminal parts disposed on the outer side surface so as to be spaced apart from each other in a first direction;
a second bobbin disposed in the recessed portion and accommodating a magnetic core therein; and
first and second coils wound on the second bobbin and spaced apart from each other in the first direction,
wherein the first coil includes a first wound portion wound on the second bobbin and a first extension portion extending from the first wound portion to a region on the outer side surface of the first bobbin to be coupled to the first terminal part, and
wherein the second coil includes a second wound portion wound on the second bobbin and a second extension portion extending from the second wound portion to a region on the outer side surface of the first bobbin to be coupled to the second terminal part.

2. The magnetic coupling device according to claim 1, wherein the second bobbin includes a pair of isolation protrusions, and
wherein the first wound portion and the second wound portion are isolated from each other by the pair of isolation protrusions.

3. The magnetic coupling device according to claim 2, wherein each of the first and second terminal parts is disposed in alignment with a virtual parallel line passing through a portion of the first coil or the second coil located farthest from each of the isolation protrusions, the virtual parallel line being parallel to a virtual straight line connecting the pair of isolation protrusions.

4. The magnetic coupling device according to claim 1, wherein the first bobbin includes a pair of bobbin extension portions extending from two opposite sides of the recessed portion, and
wherein a central portion of each of the bobbin extension portions is formed such that a distance from the recessed portion to an outermost portion of each of the bobbin extension portions in a given direction is shorter than a length of the first terminal part or the second terminal part in the given direction.

5. The magnetic coupling device according to claim 4, wherein the central portion of each of the bobbin extension portions includes a second isolation protrusion.

6. The magnetic coupling device according to claim 1, wherein each of the first and second terminal parts is mounted on the first bobbin so as to surround the upper surface, the lower surface, and the outer side surface of the first bobbin.

7. The magnetic coupling device according to claim 6, wherein each of the first and second extension portions is inserted into a region between the outer side surface and each of the first and second terminal parts.

8. The magnetic coupling device according to claim 1, wherein the first bobbin further includes a third terminal part and a fourth terminal part, and
wherein the first to fourth terminal parts are mounted outside the recessed portion so as to be disposed in regions corresponding to four quadrants of the recessed portion, respectively.

9. The magnetic coupling device according to claim 1, wherein the first extension portion and the second extension portion escape from the recessed portion and diverge from each other at an increasing angle to be connected to the first terminal part and the second terminal part, respectively.

10. The magnetic coupling device according to claim 1, wherein the first bobbin further includes a guide groove portion formed in an outer surface thereof.

11. The magnetic coupling device according to claim 1, wherein a start angle at which the first extension portion and the second extension portion escape from the recessed portion is 250 or more with respect to a virtual straight line connecting the pair of isolation protrusions.

12. The magnetic coupling device according to claim 11, wherein the start angle is 50° or less.

13. The magnetic coupling device according to claim 2, wherein each of the first and second terminal parts is spaced apart from the isolation protrusion by 5 mm or more.

14. The magnetic coupling device according to claim 4, wherein the first bobbin is formed to be at least partially convex in an outward direction along the shape of the recessed portion.

15. The magnetic coupling device according to claim 1, wherein an angle θ1 between a last turn of the first coil and a last turn of the second coil corresponding thereto is 200 to 100°.

16. The magnetic coupling device according to claim 12, wherein an angle θ2 formed by the first terminal part and the second terminal part with respect to a center of the second bobbin is 200 to 100°.

17. The magnetic coupling device according to claim 16, wherein an angle ratio θ2/θ1 is 0.2 to 5.

18. The magnetic coupling device according to claim 10, wherein the guide groove portion further includes a first guide groove portion and a second guide groove portion, and the first extension portion and the second extension portion are disposed in the first guide portion and the second guide portion, respectively.

19. The magnetic coupling device according to claim 10, wherein the guide groove portion is connected to the recessed portion in which the second bobbin is disposed.

20. The magnetic coupling device according to claim 1, wherein the first bobbin includes radial extension portions extending from the recessed portion in a radial direction, and each of the first and second terminal parts is mounted on each of the radial extension portions.
